(19) United States
(12) Patent Application Publication
(10) Pub. No.: US 2014/0059096 A1
(43) Pub. Date: Feb. 27, 2014

(54) DIVIDING DEVICE AND DIVIDING METHOD

(71) Applicant: FUJITSU LIMITED, Kawasaki-shi (JP)

(72) Inventor: Kenichi Kitamura, Kawasaki (JP)

(21) Appl. No.: 13/921,238

(22) Filed: Jun. 19, 2013

(30) Foreign Application Priority Data
Aug. 22, 2012 (JP) 2012-183418

(51) Int. Cl. G06F 5/01; G06F 7/485; G06F 7/487

(52) U.S. Cl. CPC G06F 5/012; G06F 7/487; G06F 7/485
USPC 708/209

(57) ABSTRACT

A dividing device includes: shifting circuits which left-shift the mantissa parts of the dividend and the divisor by a first and a second count values; a digit number arithmetic circuit which calculates a quotient digit number expected value based on the first count value and the second count value; a dividing circuit which outputs a quotient and a remainder in sequence on a digit-by-digit basis based on the mantissa parts of the dividend and the divisor left-shifted by the shifting circuits; a subtracting circuit which subtracts an exponent part of the floating-point number being the divisor from an exponent part of the floating-point number being the dividend to output a resultant value; and a control circuit which outputs a mantissa part and an exponent part of a floating-point number being a quotient.

### CROSS-REFERENCE TO RELATED APPLICATION

This application is based upon and claims the benefit of priority of the prior Japanese Patent Application No. 2012-183418, filed on Aug. 22, 2012, the entire contents of which are incorporated herein by reference.

### FIELD

The embodiments discussed herein are directed to a dividing device and a dividing method.

### BACKGROUND

There has been known a floating-point dividing device having a dividing circuit for performing division of mantissa parts of normalized floating-point numbers (for example, refer to Patent Document 1). A first zero detecting circuit detects the number of zeros consecutive in higher places of a mantissa part of a normalized floating-point number or a fixed point number being a dividend. A second zero detecting circuit detects the number of zeros consecutive in higher places of a mantissa part of a normalized floating-point number or a fixed-point number being a divisor. A first left-shifting circuit left-shifts the dividend by the number of the zeros detected by the first zero detecting circuit to supply the resultant to the dividing circuit. A second left-shifting circuit left-shifts the divisor by the number of the zeros detected by the second zero detecting circuit to supply the resultant to the dividing circuit. A subtractor performs subtraction of the numbers of the zeros detected by the first and second zero detecting circuits. A shifting circuit right-shifts or left-shifts a result of division that the dividing circuit performs on the dividend and the divisor left-shifted by the first and second left-shifting circuits, by an absolute value of a number indicated by a subtraction result of the subtractor, according to whether the subtraction result is positive or negative.

[Patent Document 1] Japanese Laid-open Patent Publication No. 05-40609

In Patent Document 1, it is possible to perform division of floating-point numbers of a format capable of converting a denormalized number to a normalized number, such as a binary floating-point format of IEEE754. However, in Patent Document 1, it is difficult to perform division of floating-point numbers of a format where a normalized number is not defined at all, such as a decimal floating-point format of IEEE754-2008.

### SUMMARY

A dividing device includes: a first counting circuit which counts the number of zeros consecutive in higher places of a mantissa part of a floating-point number being a dividend; a second counting circuit which counts the number of zeros consecutive in higher places of a mantissa part of a floating-point number being a divisor; a first shifting circuit which left-shifts the mantissa part of the dividend by a first count value counted by the first counting circuit; a second shifting circuit which left-shifts the mantissa part of the divisor by a second count value counted by the second counting circuit; a digit number arithmetic circuit which calculates a quotient digit number expected value based on the first count value and the second count value; a dividing circuit which outputs a quotient and a remainder in sequence on a digit-by-digit basis based on the mantissa part of the dividend left-shifted by the first shifting circuit and the mantissa part of the divisor left-shifted by the second shifting circuit; a subtracting circuit which subtracts an exponent part of the floating-point number being the divisor from an exponent part of the floating-point number being the dividend to output a resultant value; and a control circuit which outputs the quotient output by the dividing circuit as a mantissa part of a floating-point number being a quotient and outputs the value output by the subtracting circuit as an exponent part of the floating-point number being the quotient, when a digit number of the quotient output by the dividing circuit becomes the quotient digit number expected value and the remainder output by the dividing circuit becomes zero.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory chart of a dividing method of fixed-point numbers.

FIG. 2 is an explanatory chart of a dividing method of floating-point numbers.

FIG. 3 is an explanatory chart of a dividing method of denormalized fixed-precision floating-point numbers of a format in which a normalized number is not defined.

FIG. 4 is an explanatory chart of a first dividing method according to a first embodiment.

FIG. 5 is an explanatory chart of a second dividing method according to the first embodiment.

FIG. 6 is an explanatory chart of a third dividing method according to the first embodiment.

FIG. 7 is an explanatory chart of a fourth dividing method according to the first embodiment.

FIG. 8 is a diagram depicting a structure example of a dividing device according to the first embodiment.

FIG. 9 is a diagram depicting a structure example of a division loop circuit in FIG. 8.

FIG. 10A to FIG. 10D are charts representing a control method of a control circuit in FIG. 8.

FIG. 11 is a diagram depicting a structure example of a dividing device according to a second embodiment.

FIG. 12A to FIG. 12D are charts representing a control method of a control circuit in FIG. 11.

FIG. 13 is a chart depicting a structure example of a dividing device according to a third embodiment.

FIG. 14A and FIG. 14B are charts representing a control method of a control circuit in FIG. 13.

### DESCRIPTION OF EMBODIMENTS

### First Embodiment

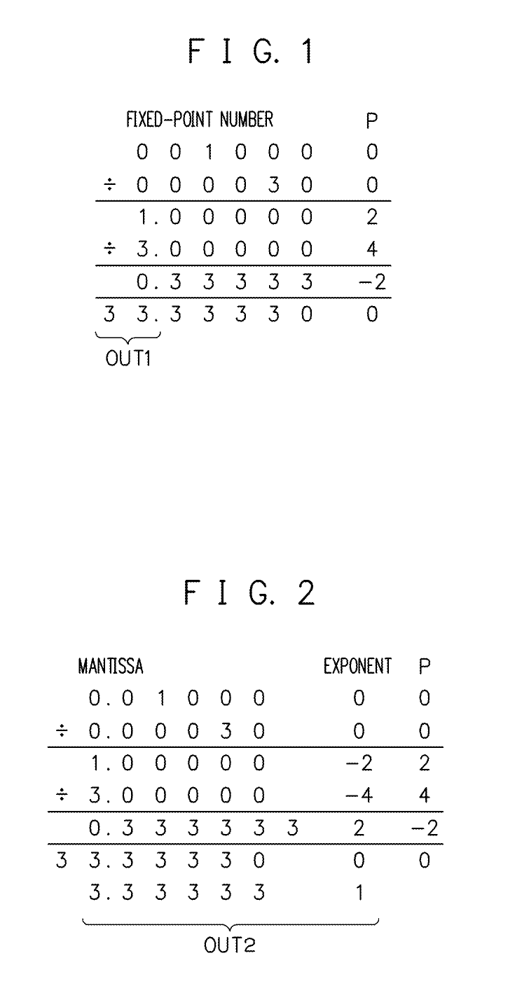

FIG. 1 is an explanatory chart of a dividing method of fixed-point numbers. “001000” is a fixed-point decimal number being a dividend. “000030” is a fixed-point decimal number being a divisor. A first reading zero count value P1 is the number of zeros consecutive in higher places of the dividend “001000” and is “2”. A second reading zero count value P2 is the number of zeros consecutive in higher places of the divisor “000030” and is “4”. “1.00000” is a normalized number resulting from left-shift of the dividend “001000” by “2” being the first reading zero count value P1. “3.00000” is a normalized number resulting from left-shift of the divisor “000030” by “4” being the second reading zero count value P2. “0.33333” is a quotient of division of the normalized number “1.00000” of the dividend by the normalized number “3.00000” of the divisor. “−2” being a value P on the right thereof is expressed by P1−P2=2−4=−2. “33.33330” being a quotient is a value resulting from right-shift of the quotient “0.33333” by “−2” being the value P. An output OUT1 of the quotient is a fixed-point number being “33”. “33” is an integer part of the quotient “33.33330”.

FIG. 2 is an explanatory chart of a dividing method of floating-point numbers. The floating-point numbers each have a mantissa part sf and an exponent part exp and are expressed by sf×10^{exp} in the case of a decimal number. A dividend has a mantissa part “0.01000” and an exponent part “0”. A divisor has a mantissa part “0.00030” and an exponent part “0”. A first reading zero count value P1 is the number of zeros consecutive in higher places of the mantissa part “0.01000” of the dividend and is “2”. A second reading zero count value P2 is the number of zeros consecutive in higher places of the divisor “0.00030” and is “4”. “1.00000” being a normalized mantissa part of the dividend is a normalized number resulting from left-shift of the mantissa part “0.01000” of the dividend by “2” being the first reading zero count value P1. “3.00000” being a normalized mantissa part of the divisor is a normalized number resulting from left-shift of the mantissa part “0.000030” of the divisor by “4” being the second reading zero count value P2. “−2” being a normalized exponent part of the dividend results from subtraction of “2” being the first reading zero count value P1 from the exponent part “0” of the dividend and is expressed by 0−2=−2. “−4” being a normalized exponent part of the divisor results from subtraction of “4” being the second reading zero count value P2 from the exponent part “0” of the divisor and is expressed by 0−4=−4. “0.333333” being a mantissa part of a quotient is a quotient of division of the normalized mantissa part “1.00000” of the dividend by the normalized mantissa part “3.00000” of the divisor. “2” being an exponent part of the quotient results from subtraction of the normalized exponent part “−4” of the divisor from the normalized exponent part “−2” of the dividend and is expressed by (−2)−(−4)=2. “−2” being a value P on the right thereof is expressed by P1−P2=2−4=−2. “33.33330” being a mantissa part of a quotient is a value resulting from right-shift of the mantissa part “0.333333” of the quotient by “−2” being the value P. “0” being an exponent part on the right thereof results from addition of “2” being the exponent part thereabove and “−2” being the value P and is expressed by 2+(−2)=0. The mantissa part “33.33330” and the exponent part “0” of the quotient are normalized, whereby an output OUT2 of the quotient is obtained. The output OUT2 of the quotient has a mantissa part “3.33333” and an exponent part “1”. Since the output OUT2 of the quotient is an example of a standard where a format of a normalized number is defined, such conversion to the normalized number is possible.

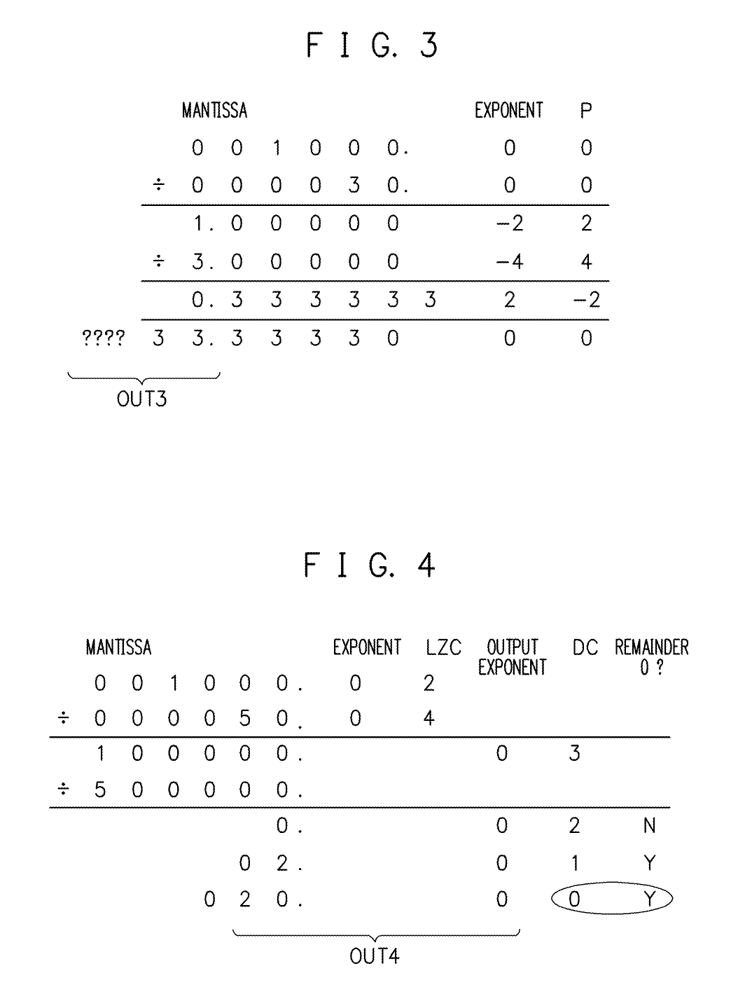

FIG. 3 is an explanatory chart of a dividing method of denormalized fixed-precision floating-point numbers of a format in which a normalized number is not defined, such as a decimal floating-point format of IEEE754-2008. A dividend has a mantissa part “001000” and an exponent part “0”. A divisor has a mantissa part “000030” and an exponent part “0”. A first reading zero count value P1 is the number of zeros consecutive in higher places of the mantissa part “001000” of the dividend and is “2”. A second reading zero count value P2 is the number of zeros consecutive in higher places of the mantissa part “000030” of the divisor and is “4”. “1.00000” being a normalized mantissa part of the dividend is a normalized number resulting from left-shift of the mantissa part “001000” of the dividend by “2” being the first reading zero count value P1. “3.00000” being a normalized mantissa part of the divisor is a normalized number resulting from left-shift of the mantissa part “000030” of the divisor by “4” being the second reading zero count value P2. “−2” being a normalized exponent part of the dividend results from subtraction of “2” being the first reading zero count value P2 from the exponent part “0” of the dividend and is expressed by 0 −2=−2. “−4” being a normalized exponent part of the divisor results from subtraction of “4” being the second reading zero count value P2 from the exponent part “0” of the divisor and is expressed by 0−4=−4. “0.333333” being a mantissa part of a quotient is a quotient of division of the normalized mantissa part “1.00000” of the dividend by the normalized mantissa part “3.00000” of the divisor. “2” being an exponent part of the quotient results from subtraction of the normalized exponent part “−4” of the divisor from the normalized exponent part “−2” of the dividend and is expressed by (−2)−(−4)=2. “−2” being a value P on the right thereof is expressed by P1−P2=2−4=−2. “33.33330” being a mantissa part of a quotient is a value resulting from right-shift of the mantissa part “0.333333” of the quotient by “−2” being the value P. “0” being an exponent part on the right thereof results from addition of “2” being the exponent part thereabove and “−2” being the value P and is expressed by 2+(−2)=0. Since a normalized number is not defined in the decimal floating-point format of IEEE754-2008, it is difficult to decide an output OUT3 of the quotient, which may cause deterioration of precision of the quotient.

FIG. 4 is an explanatory chart of a first dividing method according to a first embodiment. In the first dividing method, division of denormalized fixed-precision floating-point numbers is performed. A dividend has a mantissa part “001000” and an exponent part “0”. A divisor has a mantissa part “000050” and an exponent part

A first reading zero count value LZC1 is the number of zeros consecutive in higher places of the mantissa part “001000” of the dividend and is “2”. A second reading zero count value LZC2 is the number of zeros consecutive in higher places of the mantissa part “000050” of the divisor and is “4”. “100000” being a normalized mantissa part of the dividend is a normalized number resulting from left-shift of the mantissa part “001000” of the dividend by “2” being the first reading zero count value LZC1. “500000” being a normalized mantissa part of the divisor is a normalized number resulting from left-shift of the mantissa part “000050” of the divisor by “4” being the second reading zero count value LZC2. A quotient digit number expected value DC is expressed by LZC2−LZC1+1=4−2+1=“3”.

Next, a partial quotient, relevant to the most significant digit, of division of the normalized mantissa part “100000” of the dividend by the normalized mantissa part “500000” of the divisor becomes “0”. An exponent part of the partial product is left “0”. The quotient digit number expected value DC is decremented to “2” from “3”. Since an intermediate remainder of the above division is not 0, a determination result is “N”.

Next, a partial quotient, relevant to the second most significant digit, of the division of the normalized mantissa part “100000” of the dividend by the normalized mantissa part “500000” of the divisor becomes “2”. The partial quotient “0” relevant to the most significant digit is left-shifted and the partial quotient “2” relevant to the second most significant digit is added to the resultant, whereby an intermediate quotient becomes “02”. An exponent part of the intermediate quotient is left “0”. The quotient digit number expected value DC is decremented to “1” from “2”. Since an intermediate remainder of the above division is 0, a determination result is

Next, a partial quotient, relevant to the third most significant digit, of division of the normalized mantissa part “100000” of the dividend by the normalized mantissa part “500000” of the divisor becomes “0”. The previous intermediate quotient “02” is left-shifted and the partial quotient “0” relevant to the third most significant digit is added to the resultant, whereby an intermediate quotient becomes “020”. An exponent part of the intermediate quotient is left “0”. The quotient digit number expected value DC is decremented to “0” from “1”. Since an intermediate remainder of the above division is 0, a determination result is “Y”.

Here, since the quotient digit number expected value DC becomes 0 and the intermediate remainder becomes 0, an output OUT4 of the quotient is output. The output OUT4 of the quotient has a mantissa part “20” and an exponent part “0”.

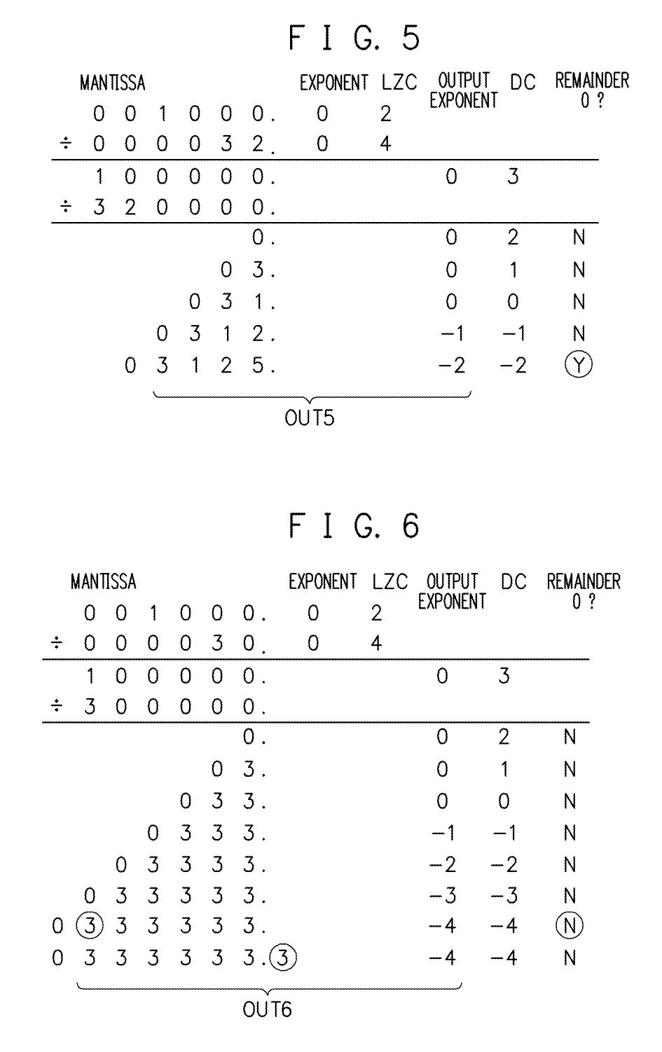

FIG. 5 is an explanatory chart of a second dividing method according to the first embodiment. In the second dividing method, division of denormalized fixed-precision floating-point numbers is performed. A dividend has a mantissa part “001000” and an exponent part “0”.

A divisor has a mantissa part “000032” and an exponent part “0”. A first reading zero count value LZC1 is the number of zeros consecutive in higher places of the mantissa part “001000” of the dividend and is “2”. A second reading zero count value LZC2 is the number of zeros consecutive in higher places of the mantissa part “000032 of the divisor and is “4”. “100000” being a normalized mantissa part of the dividend is a normalized number resulting from left-shift of the mantissa part “001000” of the dividend by “2” being the first reading zero count value LZC1. “320000” being a normalized mantissa part of the divisor is a normalized number resulting from left-shift of the mantissa part “000032” of the divisor by “4” being the second reading zero count value LZC2. A quotient digit number expected value DC is expressed by LZC2−LZC1+1=4−2+1=“3”.

Next, a partial quotient, relevant to the most significant digit, of division of the normalized mantissa part “100000” of the dividend by the normalized mantissa part “320000” of the divisor becomes “0”. An exponent part of the partial product is left “0”. The quotient digit number expected value DC is decremented to “2” from “3”. Since an intermediate remainder of the above division is not 0, a determination result is “N”.

Next, a partial quotient, relevant to the second most significant digit, of the division of the normalized mantissa part “100000” of the dividend by the normalized mantissa part “320000” of the divisor becomes “3”. The partial quotient “0” relevant to the most significant digit is left-shifted and the partial quotient “3” relevant to the second most significant digit is added to the resultant, whereby an intermediate quotient becomes “03”. An exponent part of the intermediate quotient is left “0”. The quotient digit number expected value DC is decremented to “1” from “2”. Since an intermediate remainder of the above division is not 0, a determination result is “N”.

Next, a partial quotient, relevant to the third most significant digit, of the division of the normalized mantissa part “100000” of the dividend by the normalized mantissa part “320000” of the divisor becomes “1”. The previous intermediate quotient “03” is left-shifted and the partial quotient “1” relevant to the third most significant digit is added to the resultant, whereby an intermediate quotient becomes “031”. An exponent part of the intermediate quotient is left “0”. The quotient digit number expected value DC is decremented to “0” from “1”. Since an intermediate remainder of the above division is not 0, a determination result is “N”.

Here, the quotient digit number expected value DC becomes 0, but the intermediate remainder has not become 0. In this case, since the quotient digit number expected value DC falls out of expectation, the division is continued until the intermediate remainder becomes 0.

Next, a partial quotient, relevant to the fourth most significant digit, of the division of the normalized mantissa part “100000” of the dividend by the normalized mantissa part “320000” of the divisor becomes “2”. The previous intermediate quotient “031” is left-shifted and the partial quotient “2” relevant to the fourth most significant digit is added to the resultant, whereby an intermediate quotient becomes “0312”. An exponent part of the intermediate quotient is decremented to “−1” from “0”. The quotient digit number expected value DC is decremented to “−1” from “0”. Since an intermediate remainder of the above division is not 0, a determination result is “N”.

Next, a partial quotient, relevant to the fifth most significant digit, of the division of the normalized mantissa part “100000” of the dividend by the normalized mantissa part “320000” of the divisor becomes “5”. The previous intermediate quotient “0312” is left-shifted and the partial quotient “5” relevant to the fifth most significant digit is added to the resultant, whereby an intermediate quotient becomes “03125”. An exponent part of the intermediate quotient is decremented to “−2” from “−1”. The quotient digit number expected value DC is decremented to “−2” from “−1”. Since an intermediate remainder of the above division is 0, a determination result is “Y”.

Here, since the quotient digit number expected value DC becomes 0 or less and the intermediate remainder becomes 0, an output OUTS of the quotient is output. The output OUTS of the quotient has a mantissa part “3125” and an exponent part “−2”.

FIG. 6 is an explanatory chart of a third dividing method according to the first embodiment. In the third dividing method, division of denormalized fixed-precision floating-point numbers is performed. A dividend has a mantissa part “001000” and an exponent part “0”. A divisor has a mantissa part “000030” and an exponent part

A first reading zero count value LZC1 is the number of zeros consecutive in higher places of the mantissa part “001000” of the dividend and is “2”. A second reading zero count value LZC2 is the number of zeros consecutive in higher places of the mantissa part “000030” of the divisor and is “4”. “100000” being a normalized mantissa part of the dividend is a normalized number resulting from left-shift of the mantissa part “001000” of the dividend by “2” being the first reading zero count value LZC1. “300000” being a normalized mantissa part of the divisor is a normalized number resulting from left-shift of the mantissa part “000030” of the divisor by “4” being the second reading zero count value LZC2. A quotient digit number expected value DC is expressed by LZC2−LZC1+1=4−2+1=“3”.

Next, a partial quotient, relevant to the most significant digit, of division of the normalized mantissa part “100000” of the dividend by the normalized mantissa part “300000” of the divisor becomes “0”. An exponent part of the partial product is left “0”. The quotient digit number expected value DC is decremented to “2” from “3”. Since an intermediate remainder of the above division is not 0, a determination result is “N”.

Next, a partial quotient, relevant to the second most significant digit, of the division of the normalized mantissa part “100000” of the dividend by the normalized mantissa part “300000” of the divisor becomes “3”. The partial quotient “0” relevant to the most significant digit is left-shifted and the partial quotient “3” relevant to the second most significant digit is added to the resultant, whereby an intermediate quotient becomes “03”. An exponent part of the intermediate quotient is left “0”. The quotient digit number expected value DC is decremented to “1” from “2”. Since an intermediate remainder of the above division is not 0, a determination result is “N”.

Next, a partial quotient, relevant to the third most significant digit, of the division of the normalized mantissa part “100000” of the dividend by the normalized mantissa part “300000” of the divisor becomes “3”. The previous intermediate quotient “03” is left-shifted and the partial quotient “3” relevant to the third most significant digit is added to the resultant, whereby an intermediate quotient becomes “033”. An exponent part of the intermediate quotient is left “0”. The quotient digit number expected value DC is decremented to “0” from “1”. Since an intermediate remainder of the above division is not 0, a determination result is “N”.

Here, the quotient digit number expected value DC becomes 0 but the intermediate remainder has not become 0. In this case, since the quotient digit number expected value DC falls out of expectation, the division is continued until the intermediate remainder becomes 0.

Next, a partial quotient, relevant to the fourth most significant digit, of the division of the normalized mantissa part “100000” of the dividend by the normalized mantissa part “300000” of the divisor becomes “3”. The previous intermediate quotient “033” is left-shifted and the partial quotient “3” relevant to the fourth most significant digit is added to the resultant, whereby an intermediate quotient becomes “0333”. An exponent part of the intermediate quotient is decremented to “−1” from “0”. The quotient digit number expected value DC is decremented to “−1” from “0”. Since an intermediate remainder of the above division is not 0, a determination result is “N”.

Next, a partial quotient, relevant to the fifth most significant digit, of the division of the normalized mantissa part “100000” of the dividend by the normalized mantissa part “300000” of the divisor becomes “3”. The previous intermediate quotient “0333” is left-shifted and the partial quotient “3” relevant to the fifth most significant digit is added to the resultant, whereby an intermediate quotient becomes “03333”. An exponent part of the intermediate quotient is decremented to “−2” from “−1”. The quotient digit number expected value DC is decremented to “−2” from “−1”. Since an intermediate remainder of the above division is not 0, a determination result is “N”.

Next, a partial quotient, relevant to the sixth most significant digit, of the division of the normalized mantissa part “100000” of the dividend by the normalized mantissa part “300000” of the divisor becomes “3”. The previous intermediate quotient “03333” is left-shifted and the partial quotient “3” relevant to the sixth most significant digit is added to the resultant, whereby an intermediate quotient becomes “033333”. An exponent part of the intermediate quotient is decremented to “−3” from “−2”. The quotient digit number expected value DC is decremented to “−3” from “−2”. Since an intermediate remainder of the above division is not 0, a determination result is “N”.

Here, it is assumed that a digit number of fixed precision of a quotient is six. A digit number of the intermediate quotient “033333” reaches six digits being the fixed precision and the intermediate remainder is not 0. However, the most significant digit of the intermediate quotient “033333” is “0”. In this case, the value does not change even if the most significant digit “0” is deleted, and therefore, the division is continued.

Next, a partial quotient, relevant to the seventh most significant digit, of the division of the normalized mantissa part “100000” of the dividend by the normalized mantissa part “300000” of the divisor becomes “3”. The previous intermediate quotient “033333” is left-shifted and the partial quotient “3” relevant to the seventh most significant digit is added to the resultant, whereby an intermediate quotient whose fixed precision is six digits becomes “333333”. An exponent part of the intermediate quotient is decremented to “−4” from “−3”. The quotient digit number expected value DC is decremented to “−4” from “−3”. Since an intermediate remainder of the above division is not 0, a determination result is “N”.

Here, the intermediate quotient “333333” whose fixed precision is six digits reaches six digits being the fixed precision and the intermediate remainder is not 0. The most significant digit of the intermediate quotient “333333” is “3” and is not “0”. In this case, for rounding, “3” being a partial quotient, relevant to the eighth most significant digit, of the division of the normalized mantissa part “100000” of the dividend by the normalized mantissa part “300000” of the divisor is calculated. Then, an output OUT6 of the quotient is output. The output OUT6 of the quotient has a mantissa part “333333”, the partial quotient “3” relevant to the eighth most significant digit for the rounding, and an exponent part “−4”. Next, by the rounding, the partial quotient “3” relevant to the eighth most significant digit, for instance, is rounded off, and a quotient having a mantissa part “333333” and an exponent part “−4” is output.

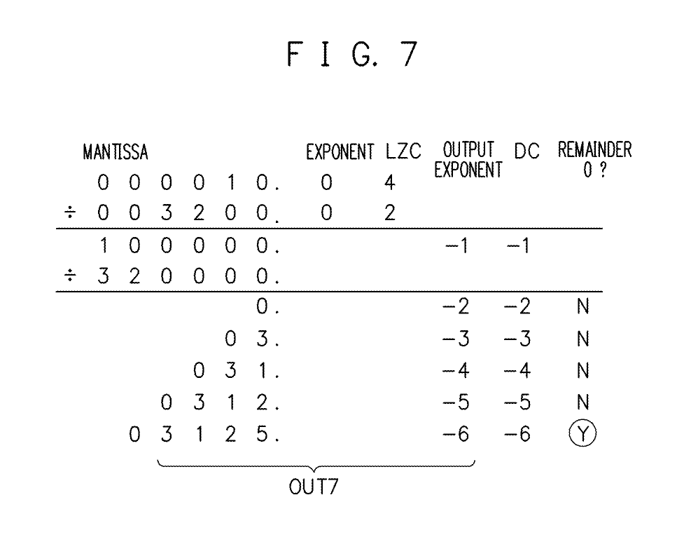

FIG. 7 is an explanatory chart of a fourth dividing method according to the first embodiment. In the fourth dividing method, division of denormalized fixed-precision floating-point numbers is performed. A dividend has a mantissa part “000010” and an exponent part “0”. A divisor has a mantissa part “003200” and an exponent part “0”. A first reading zero count value LZC1 is the number of zeros consecutive in higher places of the mantissa part “000010” of the dividend and is “4”. A second reading zero count value LZC2 is the number of zeros consecutive in higher places of the mantissa part “003200” of the divisor and is “2”. “100000” being a normalized mantissa part of the dividend is a normalized number resulting from left-shift of the mantissa part “000010” of the dividend by “4” being the first reading zero count value LZC1. “320000” being a normalized mantissa part of the divisor is a normalized number resulting from left-shift of the mantissa part “003200” of the divisor by “2” being the second reading zero count value LZC2. A quotient digit number expected value DC is expressed by LZC2−LZC1+1=2−4+1=“−1”.

Here, since the quotient digit number expected value DC is smaller than zero, the division is continued until an intermediate remainder becomes 0.

Next, a partial quotient, relevant to the most significant digit, of division of the normalized mantissa part “100000” of the dividend by the normalized mantissa part “320000” of the divisor becomes “0”. An exponent part of the partial quotient is decremented to “−2” from “−1”.

The quotient digit number expected value DC is decremented to “−2” from “−1”. Since an intermediate remainder of the above division is not 0, a determination result is “N”.

Next, a partial quotient, relevant to the second most significant digit, of the division of the normalized mantissa part “100000” of the dividend by the normalized mantissa part “320000” of the divisor becomes “3”. The partial quotient “0” relevant to the most significant digit is left-shifted and the partial quotient “3” relevant to the second most significant digit is added to the resultant, whereby an intermediate quotient becomes “03”. An exponent part of the intermediate quotient is decremented to “−3” from

The quotient digit number expected value DC is decremented to “−3” from “−2”. Since an intermediate remainder of the above division is not 0, a determination result is “N”.

Next, a partial quotient, relevant to the third most significant digit, of the division of the normalized mantissa part “100000” of the dividend by the normalized mantissa part “320000” of the divisor becomes “1”. The previous intermediate quotient “03” is left-shifted and the partial quotient “1” relevant to the third most significant digit is added to the resultant, whereby an intermediate quotient becomes “031”.

An exponent part of the intermediate quotient is decremented to “−4” from “−3”. The quotient digit number expected value DC is decremented to “−4” from “−3”. Since an intermediate remainder of the above division is not 0, a determination result is “N”.

Next, a partial quotient, relevant to the fourth most significant digit, of the division of the normalized mantissa part “100000” of the dividend by the normalized mantissa part “320000” of the divisor becomes “2”. The previous intermediate quotient “031” is left-shifted and the partial quotient “2” relevant to the fourth most significant digit is added to the resultant, whereby an intermediate quotient becomes “0312”. An exponent part of the intermediate quotient is decremented to “−5” from “−4”. The quotient digit number expected value DC is decremented to “−5” from “−4”. Since an intermediate remainder of the above division is not 0, a determination result is “N”.

Next, a partial quotient, relevant to the fifth most significant digit, of the division of the normalized mantissa part “100000” of the dividend by the normalized mantissa part “320000” of the divisor becomes “5”. The previous intermediate quotient “0312” is left-shifted and the partial quotient “5” relevant to the fifth most significant digit is added to the resultant, whereby an intermediate quotient becomes “03125”. An exponent part of the intermediate quotient is decremented to “−6” from “−5”. The quotient digit number expected value DC is decremented to “−6” from “−5”. Since an intermediate remainder of the above division is 0, a determination result is “Y”.

Here, since the quotient digit number expected value DC becomes 0 or less and the intermediate remainder becomes 0, an output OUT7 of the quotient is output. The output OUT7 of the quotient has a mantissa part “3125” and an exponent part “−6”.

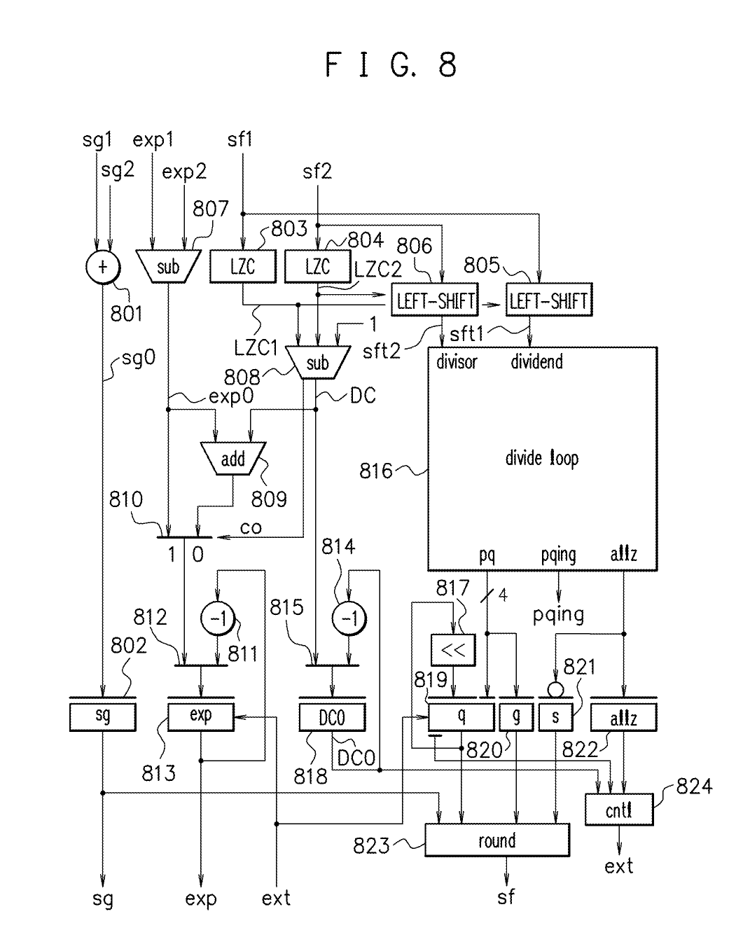

FIG. 8 is a diagram depicting a structure example of a dividing device according to the first embodiment. This dividing device is capable of performing the above-described divisions in FIG. 4 to FIG. 7. A floating-point number being a dividend has a positive-negative sign sg1, a mantissa part sf1, and an exponent part exp1, and is expressed by (−1)^{sg1}×sf1×10^{exp1} in the case of a decimal number. A floating-point number being a divisor has a positive-negative sign sg2, a mantissa part sf2, and an exponent part exp2 and is expressed by (−1)^{sg2}×sf2×10^{exp2} in the case of a decimal number. The positive-negative signs sg1 and sg2 represent positive when they are “0” and represent negative when they are “1”.

An exclusive logical sum circuit 801 is a positive-negative sign arithmetic circuit and outputs an exclusive logical sum value of the positive-negative sign sg1 of the dividend and the positive-negative sign sg2 of the divisor as a positive-negative sign sg0. That is, the exclusive logical sum circuit 801 receives the positive-negative sign sg1 of the floating-point number being the dividend and the positive-negative sign sg2 of the floating-point number being the divisor, and when the both positive-negative signs are the same, it outputs the positive-negative sign sg0 of a floating-point number being a quotient as positive (value “0”), and when the both positive-negative signs are different, it outputs the positive-negative sign sg0 of the floating-point number being the quotient as negative (value “1”). A register 802 holds the positive-negative sign sg0 and outputs the positive-negative sign sg0 as a positive-negative sign sg of the floating-point number being the quotient.

A subtracting circuit 807 outputs a value exp0 (=exp1−exp2) resulting from subtraction of the exponent part exp2 of the floating-point number being the divisor from the exponent part exp1 of the floating-point number being the dividend.

A first reading zero count circuit 803 counts, as the first reading zero count value LZC1, the number of zeros consecutive in higher places of the mantissa part sf1 of the floating-point number being the dividend. A second reading zero count circuit 804 counts, as the second reading zero count value LZC2, the number of zeros consecutive in higher places of the mantissa part sf2 of the floating-point number being the divisor.

A first left-shifting circuit 805 left-shifts the mantissa part sf1 of the dividend by the first reading zero count value LZC1 and outputs a normalized mantissa part sft1 of the dividend. A second left-shifting circuit 806 left-shifts the mantissa part sf2 of the divisor by the second reading zero count value LZC2 and outputs a normalized mantissa part sft2 of the divisor.

A digit number arithmetic circuit 808 subtracts the first reading zero count value LZC1 from the second reading zero count value LZC2 and adds 1 to a subtraction value, thereby calculating the resultant value as the quotient digit number expected value DC (=LZC2−LZC1+1) and outputs a carry-out co. The carry-out co is “1” when the quotient digit number expected value DC is zero or more, and is “0” when the quotient digit number expected value DC is a negative value.

An adding circuit 809 adds the value exp0 and the quotient digit number expected value DC and outputs the value exp0+DC. A selector 810 selects and outputs the value exp0 when the carry-out co is “1”, and selects and outputs the value exp0+DC when the carry-out co is “0” (for example, the case of FIG. 7).

A decrementing circuit 811 decrements an output value exp of a register 813 to output the value exp−1. A selector 812 selects and outputs the output value of the selector 810 at the time of the first division for a partial quotient, and selects and outputs the output value of the decrementing circuit 811 at the time of the division for the partial quotient from the second time onward. The value of the register 813 is updated to the output value of the selector 812 according to a register update change signal ext or the like output by a control circuit 824, and is output as the exponent part exp of the floating-point number being the quotient.

A decrementing circuit 814 decrements an output value DC0 of a register 818 to output the value DC0−1. A selector 815 selects and outputs the quotient digit number expected value DC at the time of the first division for the partial quotient, and selects and outputs the output value of the decrementing circuit 814 at the time of the division for the partial quotient from the second time onward. The value of the register 818 is updated to the output value of the selector 815 under a later-described condition and is output as the value DC0.

A division loop circuit (dividing circuit) 816 sequentially outputs a quotient pq and a remainder allz on a digit-by-digit basis based on the normalized mantissa part sft1 of the dividend and the normalized mantissa part sft2 of the divisor.

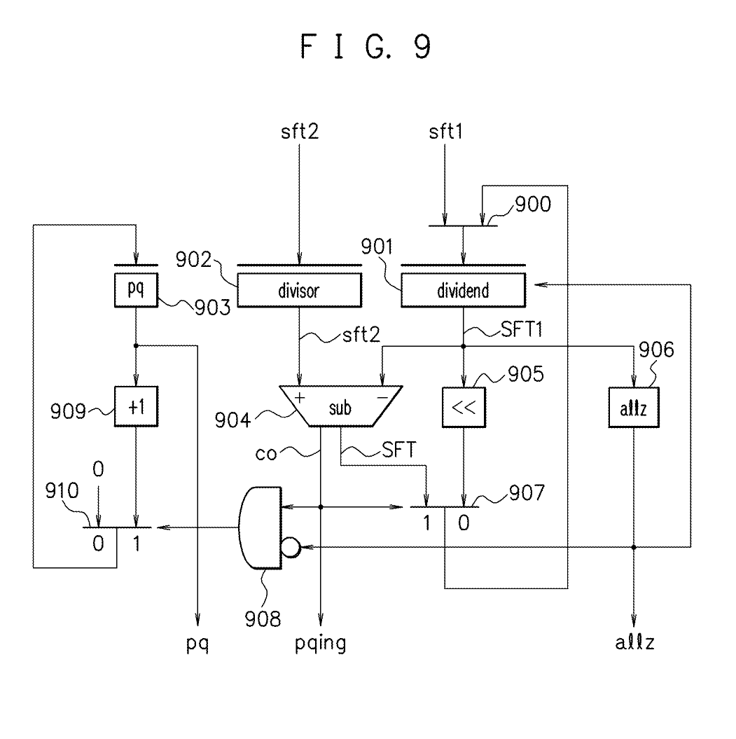

FIG. 9 is a diagram depicting a structure example of the division loop circuit 816 in FIG. 8. Hereinafter, an example of the division loop circuit 816 is presented, but various structures are adoptable. A selector 900 selects and outputs the normalized mantissa part sft1 of the dividend at the time of the first division for the partial quotient, and selects and outputs an output value of a selector 907 at the time of the division for the partial quotient from the second time onward. A value of a register 901 is updated to the output value of the selector 900 according to the output value allz of a register 906 and is output as a mantissa part SFT1 of the dividend. A register 902 stores the normalized mantissa part sft2 of the divisor and outputs the mantissa part sft2.

A subtracting circuit 904 outputs a value resulting from subtraction of the mantissa part SFT1 of the dividend from the mantissa part sft2 of the divisor, as an intermediate remainder SFT (=sft2−SFT1) and outputs the carry-out co. The carry-out co is “1” when the intermediate remainder SFT is zero or more, and is “0” when the intermediate remainder SFT is a negative value.

A left-shifting circuit 905 left-shifts the mantissa part SFT1 of the dividend by one digit to output the resultant. The selector 907 selects and outputs the intermediate remainder SFT when the carry-out co is “1”, and selects and outputs the output value of the left-shifting circuit 905 when the carry-out co is “0”. The all-zero circuit 906 outputs the all-zero value allz being “1” when digits of the value SFT1 are all 0, and in other cases, it outputs the all-zero value allz being “0”. That is, the case where the all-zero value allz is “1” indicates that the intermediate remainder SFT1 is 0. When the all-zero value allz is “1”, the value of the register 901 is 0 and therefore is not updated and 0 is maintained.

A logical product (AND) circuit 908 outputs a logical product value of an inverted logical value of the all-zero value allz and the carry-out co. A register 903, whose initial value is 0, outputs the partial quotient pq. An incrementing circuit 909 increments the partial quotient pq every time the subtracting circuit 904 performs the subtraction, and outputs pq+1. A selector 910 selects and outputs the value “0” when the output value of the logical product circuit 908 is “0”, and selects and outputs the output value of the incrementing circuit 909 when the output value of the logical product circuit 908 is “1”. The register 903 stores the output value of the selector 910 to output the partial quotient pq.

As described above, the carry-output co being “1” indicates that the subtracting circuit 904 is capable of the subtraction and therefore, the selector 907 selects the value SFT and the selector 901 selects the output value of the incrementing circuit 909. However, when the all-zero value allz is “1”, the intermediate remainder SFT1 is zero and it is necessary to stop the arithmetic of the partial quotient, and therefore, the selector 910 selects the value “0”. On the other hand, the carry-out co being “0” indicates that the subtracting circuit 904 is not capable of the subtraction, and it is determined that the derivation of the partial quotient relevant to the digit in question is finished, and the selector 907 selects the output value of the left-shifting circuit 905, and the selector 910 selects the value “0”. The carry-out co is output as a value pqing.

In FIG. 8, the partial quotient pq of the division loop circuit 816 is input to the least significant digit of a q register 819. A left-shifting circuit 817 left-shifts the value held by the q register 819 by one digit to output the resultant. The output value of the left-shifting circuit 817 is input to the most significant digit of the q register 819 and the partial quotient pq is input to its least significant digit.

The partial quotient pq for rounding is input to a g register 820 as presented in FIG. 8. The g register 820 is updated when the intermediate remainder is not zero at a stage when the division loop is finished.

The inverted logical value of the all-zero value allz is input to an s register 821 as a rounding sticky bit. The s register 821 is updated when the intermediate remainder is not zero at the stage when the division loop is finished. The all-zero value allz is input to an all-zero register 822.

The registers 813, 818 to 822 are updated every time the partial quotient relevant to one digit is calculated. That is, while the signal pqing output from the division loop circuit 816 is “1”, the update of the values of the registers 813, 818 to 822 is stopped, and when the signal pqing becomes “0”, the values of the registers 813, 818 to 822 are updated.

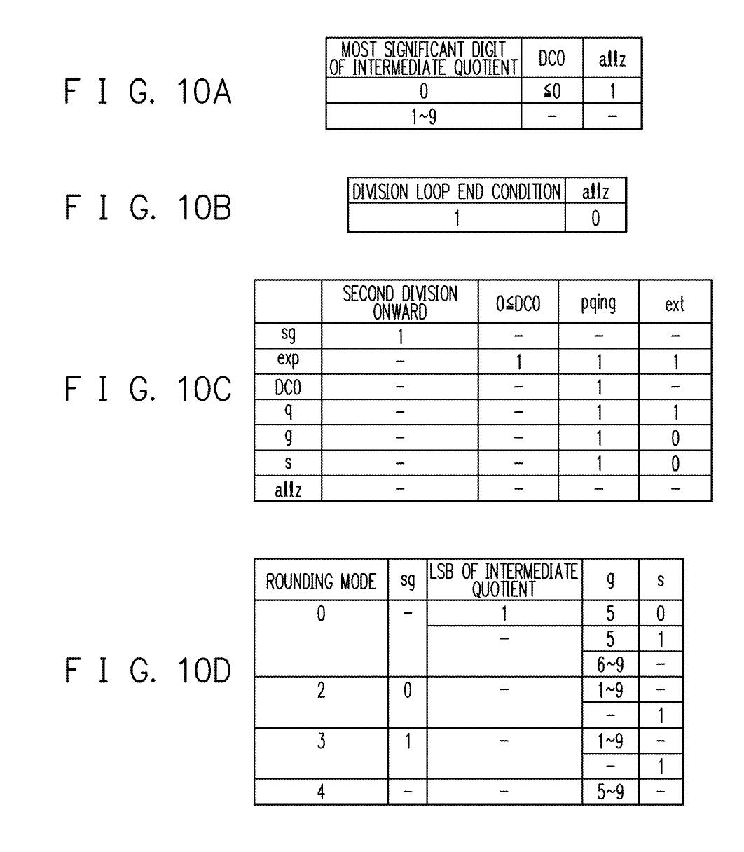

FIG. 10A to FIG. 10D are charts representing a control method of the control circuit 824 in FIG. 8. The control circuit 824 receives the output value DC0 of the register 818, the most significant digit of the q register 819, and the output value allz of the all-zero register 822 and outputs the register update change signal ext.

FIG. 10A is a chart representing a method for the control circuit 824 to determine whether or not a division loop end condition is satisfied. When the most significant digit of the intermediate quotient of the register 819 is “0”, the control circuit 824 determines that the division loop end condition is satisfied if the quotient digit number expected value DC0 is 0 or less and the all-zero value allz is 1. Further, when the most significant digit of the intermediate quotient of the register 819 is any one of “1” to “9”, it means that the intermediate quotient reaches the digit number of fixed precision as presented in FIG. 6, and therefore, the control circuit 824 determines that the division loop end condition is satisfied.

FIG. 10B is an explanatory chart of the register update change signal ext output by the control circuit 824. When the division loop end condition in FIG. 10A is satisfied and the all-zero value allz is “0”, the control circuit 824 outputs the signal ext being “1”, and in other cases, the control circuit 824 outputs the signal ext being “0”. That is, when the most significant digit of the intermediate quotient of the register 819 is any one of “1” to “9” as presented in FIG. 6 and the all-zero value allz is “0”, the signal ext becomes “1”.

FIG. 10C is a chart representing an update stop condition of the registers 802, 813, 818 to 822. The register 802 of the positive-negative sign sg is updated at the time of the first division for the partial quotient, and at the time of the division for the partial quotient from the second time onward, the update of the g register 802 is stopped. The update of the register 813 of the exponent part exp is stopped when the digit number expected value DC0 is zero or more, or the value pqing is “1”, or the signal ext is “1”. The update of the register 818 of the digit number expected value DC0 is stopped when the value pqing is “1”. The update of the q register 819 is stopped when the value pqing is “1” or the signal ext is “1”. The update of the g register 820 is stopped when the value pqing is “1” or the signal ext is “0”. The update of the s register 821 is stopped when the value pqing is “1” or the signal ext is “0”. The registers 802, 813, 818 to 822 are updated when the aforesaid update stop condition is not satisfied.

FIG. 10D is a chart representing a processing example of a rounding circuit 823. The control circuit 824 controls the rounding circuit 823 according to a rounding mode. The rounding circuit 823 receives the positive-negative sign sg of the register 802, the intermediate quotient of the q register 819, the partial quotient of the g register 820, and the sticky bit of the s register 821 and performs the rounding to output the mantissa part sf of the floating-point number being the quotient.

First, a case where the rounding mode is “0” will be described. In this rounding mode, the rounding circuit 823 performs rounding called bankers' rounding. When the least significant bit of the intermediate quotient of the q register 819 is “1” (when the intermediate quotient is an odd number), and when the partial quotient of the g register 820 is “5” and the sticky bit of the s register 821 is “0”, 1 is added to the intermediate quotient of the q register 819, and the resultant is output as the mantissa part sf of the quotient. For example, “3.5” becomes “4” by the rounding. Further, when the partial quotient of the g register 820 is “5” and the sticky bit of the s register 821 is “1”, the rounding circuit 823 adds 1 to the intermediate quotient of the q register 819 and outputs the resultant as the mantissa part sf of the quotient. For example, “2.51” becomes “3” by the rounding. Further, when the partial quotient of the g register 820 is any one of “6” to “9”, 1 is added to the intermediate quotient of the q register 819 and the resultant is output as the mantissa part sf of the quotient. For example, “2.6” becomes “3” by the rounding.

Next, a case where the rounding mode is “1” will be described. In this rounding mode, the rounding circuit 823 performs rounding-down. The rounding circuit 823 outputs the intermediate quotient of the q register 819 as it is as the mantissa part sf.

Next, a case where the rounding mode is “2” will be described. In this rounding mode, the rounding circuit 823 performs the rounding in a +∞ direction. When the positive-negative sign sg is “0” and the partial quotient of the g register 820 is any one of “1” to “9”, the rounding circuit 823 adds 1 to the intermediate quotient of the q register 819 and outputs the resultant as the mantissa part sf of the quotient. Further, when the positive-negative sign sg is “0” and the sticky bit of the s register 821 is “1”, the rounding circuit 823 adds 1 to the intermediate quotient of the q register 819 and outputs the resultant as the mantissa part sf of the quotient.

Next, a case where the rounding mode is “3” will be described. In this rounding mode, the rounding circuit 823 performs the rounding in a −∞ direction. When the positive-negative sign sg is “1” and the partial quotient of the g register 820 is any one of “1” to “9”, the rounding circuit 823 adds 1 to the intermediate quotient of the q register 819 and outputs the resultant as the mantissa part sf of the quotient. Further, when the positive-negative sign sg is “1” and the sticky bit of the s register 821 is “1”, the rounding circuit 823 adds 1 to the intermediate quotient of the q register 819 and outputs the resultant as the mantissa part sf of the quotient.

Next, a case where the rounding mode is “4” will be described. In this rounding mode, the rounding circuit 823 performs rounding-off. When the partial quotient of the g register 820 is any one of “5” to “9”, the rounding circuit 823 adds 1 to the intermediate quotient of the q register 819 and outputs the resultant as the mantissa part sf of the quotient.

Incidentally, when the rounding is not necessary, the update of the g register 820 and the s register 821 may be skipped, and the rounding circuit 823 may output the intermediate quotient of the q register 819 as the mantissa part sf without performing the rounding.

As a result of the above-described processing, the dividing device outputs the quotient being the floating-point number including the positive-negative sign sg, the exponent part ext, and the mantissa part sf.

In the case of FIG. 4, when the digit number of the intermediate quotient of the q register 819 becomes the quotient digit number expected value DC (the digit number expected value DC0 becomes 0) and the intermediate remainder output by the division loop circuit 816 becomes 0 (the all-zero value allz becomes 1), the control circuit 824 outputs the intermediate quotient of the q register 819 as the mantissa part sf of the floating-point number being the quotient, and outputs the value exp0 output by the subtracting circuit 807 as the exponent part exp of the floating-point number being the quotient.

In the case of FIG. 5, when the digit number of the intermediate quotient of the q register 819 becomes the quotient digit number expected value DC (the digit number expected value DC0 becomes 0) and the intermediate remainder output by the division loop circuit 816 is not zero (the all-zero value allz is not zero), the control circuit 824 causes the division loop circuit 816 to continue outputting the partial quotient pq and the intermediate remainder on a digit-by-digit basis until the intermediate remainder output by the division loop circuit 816 becomes zero (until the all-zero value allz becomes 1), and when the remainder output by the division loop circuit 816 becomes zero (when the all-zero value allz becomes 1), it outputs the intermediate quotient of the q register 819 as the mantissa part sf of the floating-point number being the quotient, and outputs the value equal to the value exp0 output by the subtracting circuit 807 from which a value by which the digit number of the intermediate quotient of the q register 819 exceeds the quotient digit number expected value DC is subtracted, as the exponent part exp of the floating-point number being the quotient.

Further, in the case of FIG. 6, when the digit number of the intermediate quotient of the q register 819 becomes the digit number of the fixed precision and the remainder output by the division loop circuit 816 is not zero (the all-zero value allz is 0), the rounding circuit 823 rounds the intermediate quotient of the q register 819 and outputs the rounded quotient as the mantissa part sf of the floating-point number being the quotient.

Further, in the case of FIG. 7, when the quotient digit number expected value DC is smaller than zero, the control circuit 824 calculates the value equal to the value exp0 output by the subtracting circuit 807 to which the quotient digit number expected value DC is added, and outputs the value equal to the addition value from which the digit number of the intermediate quotient of the q register 819 is subtracted, as the exponent part exp of the floating-point number being the quotient.

According to this embodiment, it is possible to perform the division of denormalized fixed-precision floating-point numbers. Further, since the correction of the exponent part exp by the decrementing circuit 811 takes place in parallel to the division loop operation, an overhead for correcting the exponent part exp after the division loop is finished does not occur. Further, since algorithm for calculating the partial quotient of the division loop circuit 816 is any, it is possible to use an existing division loop circuit 816.

### Second Embodiment

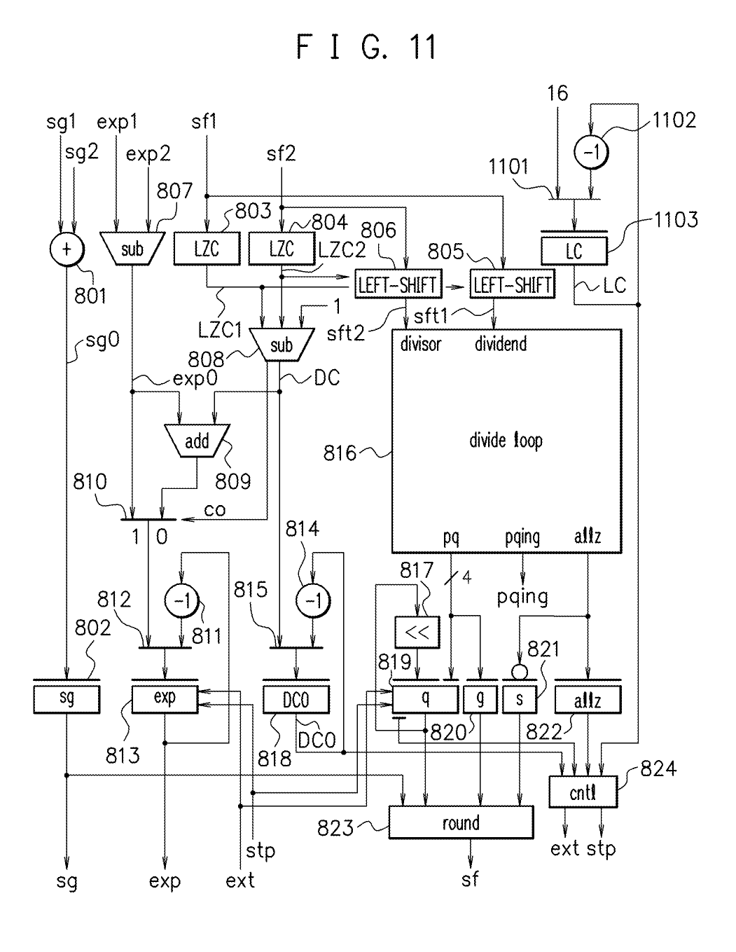

FIG. 11 is a diagram depicting a structure example of a dividing device according to a second embodiment. The dividing device in FIG. 11 is the dividing device in FIG. 8 to which a selector 1101, a decrementing circuit 1102, and a register 1103 are added. Hereinafter, points where this embodiment is different from the first embodiment will be described.

This embodiment is a fixed-latency dividing device whose input and output format is a 64-bit decimal floating-point format of IEEE754-2008. The register 1103 holds a count value LC. The decrementing circuit 1102 decrements the count value LC of the register 1103 and outputs LC−1. A digit number (for example, “16”) of the mantissa parts sf1 and sf2 are input to the selector 1101. The digit number “16” is a count value of fixed latency. The selector 1101 selects and outputs the initial value “16” at the time of the first division for a partial quotient, and selects and outputs the output value of the decrementing circuit 1102 at the time of the division for the partial quotient from the second time onward. The register 1103 holds the output value of the selector 1101. The count value LC of the register 1103 is output to the control circuit 824. The control circuit 824 receives the output value DC0 of the register 818, the most significant digit of the q register 819, the output value allz of the all-zero register 822, and the count value LC of the register 1103 and outputs the register update change signal ext and the register update stop signal stp.

The register 1103 is updated every time a partial quotient relevant to one digit is calculated similarly to the registers 813, 818 to 822. That is, while the value pqing is “1”, the update of the register 1103 is stopped, and when the value pqing becomes “0”, the register 1103 is updated.

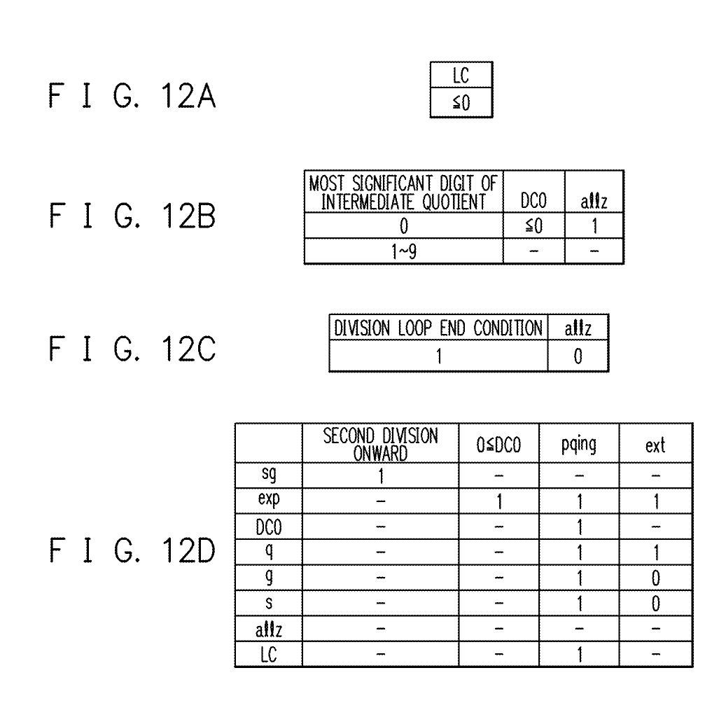

FIG. 12A to FIG. 12D are charts representing a control method of the control circuit 824 in FIG. 11. FIG. 12A is a chart representing a method for the control circuit 824 to determine whether or not the division loop end condition is satisfied. When the count value LC of the register 1103 is 0 or less, the control circuit 824 determines that the division loop end condition is satisfied.

FIG. 12B is an explanatory chart of the register update stop signal stp output by the control circuit 824. When the most significant digit of the intermediate quotient of the q register 819 is “0”, the control circuit 824 outputs the register update stop signal stp being “1” if the quotient digit number expected value DC0 is 0 or less and the all-zero value allz is 1. Further, when the most significant digit of the intermediate quotient of the register 819 is any one of “1” to “9”, since the digit number of the intermediate quotient reaches the digit number of the fixed precision as represented in FIG. 6, the control circuit 824 outputs the register update stop signal stp being “1”. When the register update stop signal stp becomes “1”, the update of the values of the registers 813 and 819 is stopped.

FIG. 12C is an explanatory chart of the register update change signal ext output by the control circuit 824. When the division loop end condition in FIG. 12A is satisfied and the all-zero value allz is “0”, the control circuit 824 outputs the signal ext being “1”, and in other cases, the control circuit 824 outputs the signal ext being “0”. That is, when the most significant digit of the intermediate quotient of the register 819 is any one of “1” to “9” as represented in FIG. 6 and the all-zero value allz is “0”, the signal ext becomes “1”.

FIG. 12D is a chart representing an update stop condition of the registers 802, 813, 818 to 822, 1103. The update stop condition of the registers 802, 813, 818 to 822 is the same as the update stop condition in FIG. 10C. The update of the register 1103 of the count value LC is stopped when the value pqing is “1”, and in other cases, it is updated.

As described above, after the count value LC (initial value is “16”) of the fixed latency is counted, the control circuit 824 outputs the mantissa part sf and the exponent part exp of the floating-point number being the quotient. In the dividing device of the first embodiment, the time from the input of the dividend and the divisor to the output of the quotient is variable latency which is variable according to the dividend and the divisor. On the other hand, in the dividing device of this embodiment, latency is fixed latency, that is, the time from the input of the dividend and the divisor to the output of the quotient is fixed irrespective of the dividend and the divisor. This facilitates processing of circuits on subsequent stages of the dividing device.

### Third Embodiment

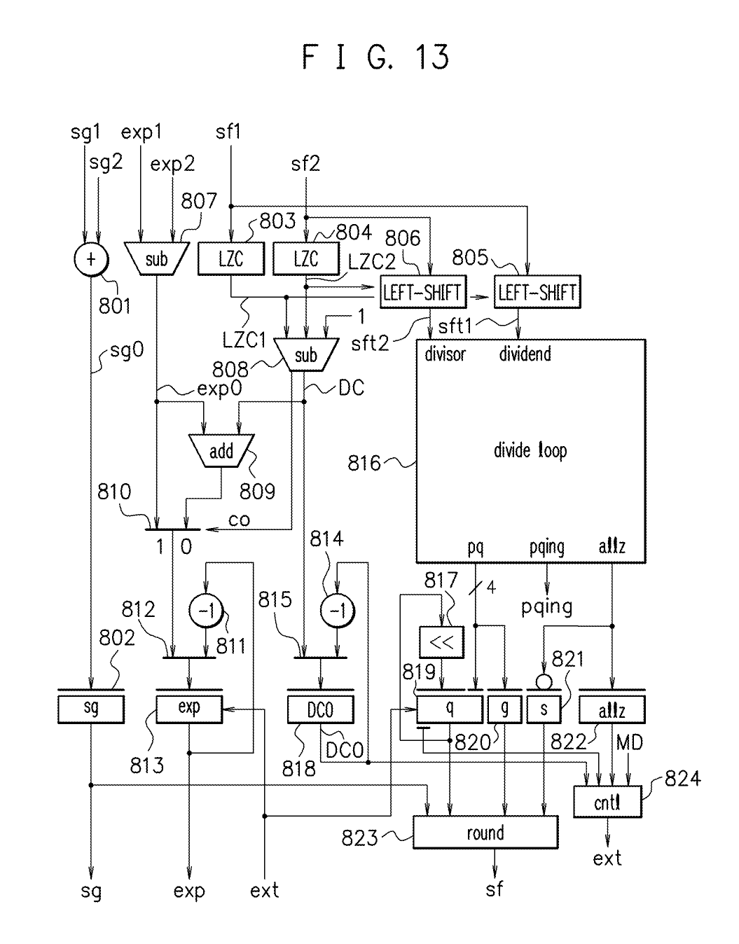

FIG. 13 is a diagram depicting a structure example of a dividing device according to a third embodiment. The dividing device in FIG. 13 is the dividing device in FIG. 8 to which a fractional mode signal MD is added. Hereinafter, points where this embodiment is different from the first embodiment will be described.

The fractional mode signal MD is input to the control circuit 824. The control circuit 824 receives the output value DC0 of the register 818, the most significant digit of the q register 819, the output value allz of the all-zero register 822, and the fractional mode signal MD and outputs the register update change signal ext. By changing the fractional mode signal MD, the dividing device of this embodiment is capable of performing division of fixed-point numbers whose input and output format is a 64-bit BCD (Binary-coded decimal) format as well as the division of the floating-point numbers of the first embodiment.

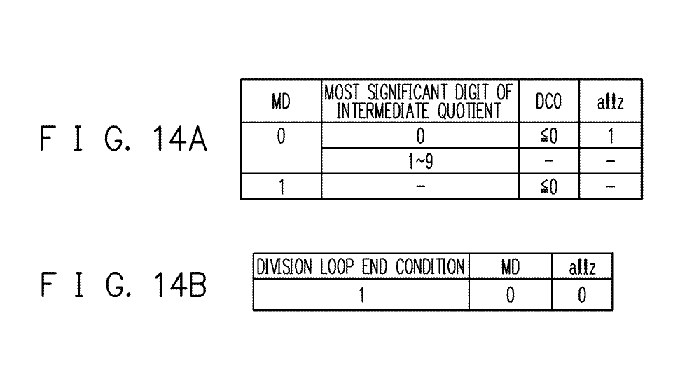

FIG. 14A and FIG. 14B are charts representing a control method of the control circuit 824 in FIG. 13. FIG. 14A is a chart representing a method for the control circuit 824 to determine whether or not the division loop end condition is satisfied.

When the fractional mode signal MD is “0”, the input and output format becomes a floating-point mode. In this case, the dividing device of this embodiment performs the same operation as that of the dividing device of the first embodiment. That is, the division loop end condition in this case is the same as the division loop end condition in FIG. 10A.

When the fractional mode signal MD is “1”, the input and output format becomes a fixed-point mode. In this case, the dividing device receives a fixed-point number being a dividend and a fixed-point number being a divisor and outputs a fixed-point number being a quotient. Concretely, the first reading zero count circuit 803 and the first left-shifting circuit 805 receive the fixed-point number being the dividend instead of the mantissa part sf1 of the dividend. The second reading zero count circuit 804 and the second left-shifting circuit 806 receive the fixed-point number being the divisor instead of the mantissa part sf2 of the divisor. The rounding circuit 823 outputs the fixed-point number being the quotient instead of the mantissa part sf of the quotient. Note that the positive-negative signs sg1, sg2 and the exponent parts exp1, exp2 are not input. In this case, when the quotient digit number expected value DC0 is 0 or less, the control circuit 824 determines that the division loop end condition is satisfied.

FIG. 14B is an explanatory chart of the register update change signal ext output by the control circuit 824. When the division loop end condition in FIG. 14A is satisfied, the fractional mode signal MD is 0, and the all-zero value allz is “0”, the control circuit 824 outputs the signal ext being “1” and in other cases the control circuit 824 outputs the signal ext being “0”.

As described above, when the fractional mode signal MD indicates the fixed-point mode, the first reading zero count circuit 803 and the first left-shifting circuit 805 receive the fixed-point number being the dividend instead of the mantissa part sf1 of the floating-point number being dividend. The second reading zero count circuit 804 and the second left-shifting circuit 806 receive the fixed-point number being the divisor instead of the mantissa part sf2 of the floating-point number being the divisor. The control circuit 824 outputs the fixed-point number being the quotient instead of the mantissa part sf of the floating-point number being the quotient.

According to this embodiment, by setting the fractional mode signal MD to 0, it is possible to perform the division of floating-point numbers as in the first embodiment, and by setting the fractional mode signal MD to 1, it is possible to perform the division of fixed-point numbers.

In the first to third embodiments, the case of a decimal number is described as an example, but it should be noted that the decimal number is not restrictive.

The above-described embodiments only illustrate concrete examples for carrying out the present invention, and the technical scope of the present invention should not be construed in a limited manner by these embodiments. That is, the present invention can be embodied in various forms without departing from its technical idea or its main features.

It is possible to perform division of denormalized fixed-precision floating-point numbers of a format in which a normalized number is not defined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A dividing device comprising:
a first counting circuit which counts the number of zeros consecutive in higher places of a mantissa part of a floating-point number being a dividend;
a second counting circuit which counts the number of zeros consecutive in higher places of a mantissa part of a floating-point number being a divisor;
a first shifting circuit which left-shifts the mantissa part of the dividend by a first count value counted by the first counting circuit;
a second shifting circuit which left-shifts the mantissa part of the divisor by a second count value counted by the second counting circuit;
a digit number arithmetic circuit which calculates a quotient digit number expected value based on the first count value and the second count value;
a dividing circuit which outputs a quotient and a remainder on a digit-by-digit basis based on the mantissa part of the dividend left-shifted by the first shifting circuit and the mantissa part of the divisor left-shifted by the second shifting circuit;
a subtracting circuit which subtracts an exponent part of the floating-point number being the divisor from an exponent part of the floating-point number being the dividend to output a resultant value; and
a control circuit which outputs the quotient output by the dividing circuit as a mantissa part of a floating-point number being a quotient and outputs the value output by the subtracting circuit as an exponent part of the floating-point number being the quotient, when a digit number of the quotient output by the dividing circuit becomes the quotient digit number expected value and the remainder output by the dividing circuit becomes zero.

2. The dividing device according to claim 1,
wherein, when the digit number of the quotient output by the dividing circuit becomes the quotient digit number expected value and the remainder output by the dividing circuit is not zero, the control circuit causes the dividing circuit to output the quotient and the remainder on a digit-by-digit basis until the remainder output by the dividing circuit becomes zero, and when the remainder output by the dividing circuit becomes zero, outputs the quotient output by the dividing circuit as the mantissa part of the floating-point number being the quotient, and outputs a value equal to the value output by the subtracting circuit from which a value by which the digit number of the quotient exceeds the quotient digit number expected value is subtracted, as the exponent part of the floating-point number being the quotient.

3. The dividing device according to claim 1, further comprising a rounding circuit which, when the digit number of the quotient output by the dividing circuit becomes a digit number of fixed precision and the remainder output by the dividing circuit is not zero, rounds the quotient output by the dividing circuit, and outputs the rounded quotient as the mantissa part of the floating-point number being the quotient.

4. The dividing device according to claim 1,
wherein, when the quotient digit number expected value is smaller than zero, the control circuit calculates a value equal to the value output by the subtracting circuit to which the quotient digit number expected value is added, and outputs a value equal to the addition value from which the digit number of the quotient is subtracted, as the exponent part of the floating-point number being the quotient.

5. The dividing device according to claim 1, further comprising a positive-negative sign arithmetic circuit which receives a positive-negative sign of the floating-point number being the dividend and a positive-negative sign of the floating-point number being the divisor, and outputs a positive-negative sign of the floating-point number being the quotient as positive when the both positive-negative signs are the same, and outputs the positive-negative sign of the floating-point number being the quotient as negative when the both positive-negative signs are different.

6. The dividing device according to claim 1,
wherein the digit number arithmetic circuit subtracts the first count value from the second count value and adds 1 to a subtraction value to calculate a resultant value as the quotient digit number expected value.

7. The dividing device according to claim 1,
wherein the control circuit outputs the mantissa part and the exponent part of the floating-point number being the quotient after counting a count value of fixed latency.

8. The dividing device according to claim 1,
wherein in a fixed-point number mode,
the first counting circuit and the first shifting circuit receive a fixed-point number being a dividend instead of the mantissa part of the floating-point number being the dividend,
the second counting circuit and the second shifting circuit receive a fixed-point number being a divisor instead of the mantissa part of the floating-point number being the divisor, and
the control circuit outputs a fixed-point number being a quotient instead of the mantissa part of the floating-point number being the quotient.

9. A dividing method comprising:
counting, by a first counting circuit, the number of zeros consecutive in higher places of a mantissa part of a floating-point number being a dividend;
counting, by a second counting circuit, the number of zeros consecutive in higher places of a mantissa part of a floating-point number being a divisor;
left-shifting, by a first shifting circuit, the mantissa part of the dividend by a first count value counted by the first counting circuit;
left-shifting, by a second shifting circuit, the mantissa part of the divisor by a second count value counted by the second counting circuit;
calculating, by a digit number arithmetic circuit, a quotient digit number expected value based on the first count value and the second count value;
outputting, by a dividing circuit, a quotient and a remainder in sequence on a digit-by-digit basis based on the mantissa part of the dividend left-shifted by the first shifting circuit and the mantissa part of the divisor left-shifted by the second shifting circuit;
subtracting, by a subtracting circuit, an exponent part of the floating-point number being the divisor from an exponent part of the floating-point number being the dividend to output a resultant value; and
outputting, by a control circuit, the quotient output by the dividing circuit as a mantissa part of a floating-point number being a quotient and outputting the value output by the subtracting circuit as an exponent part of the floating-point number being the quotient, when a digit number of the quotient output by the dividing circuit becomes the quotient digit number expected value and the remainder output by the dividing circuit becomes zero.
